(19) United States
(12) Patent Application Publication
(10) Pub. No.: US 2025/0242708 A1
(43) Pub. Date: Jul. 31, 2025

(54) METHOD FOR THE TEMPERATURE-DEPENDENT ADJUSTMENT OF A CHARGING CURRENT FOR A CHARGING PROCESS OF AN ELECTROCHEMICAL ENERGY STORE

(71) Applicant: Robert Bosch GmbH, Stuttgart (DE)

(72) Inventors: Christoph Woll, Gerlingen (DE); Martina Maurer, Rutesheim (DE)

(21) Appl. No.: 19/024,933

(22) Filed: Jan. 16, 2025

(30) Foreign Application Priority Data
Jan. 30, 2024 (DE) 10 2024 200 835.4

(51) Int. Cl. B60L 53/62; B60L 58/25

(52) U.S. Cl. CPC B60L 53/62; B60L 58/25

(57) ABSTRACT

A method for the temperature-dependent adjustment of a charging current for a charging process of at least one electrochemical energy store of an electrically driven vehicle.

### CROSS REFERENCE

The present application claims the benefit under 35 U.S.C. § 119 of German Patent Application No. DE 10 2024 200 835.4 filed on Jan. 30, 2024, which is expressly incorporated herein by reference in its entirety.

### FIELD

The present invention is based on a method for the temperature-dependent adjustment of a charging current for a charging process of at least one electrochemical energy store of an electrically driven vehicle, a device for operating an electrochemical energy store, a computer program and/or the use of a method for the temperature-dependent adjustment of a charging current for a charging process of an electrochemical energy store of an electrically driven vehicle.

### BACKGROUND INFORMATION

In the future, electrically driven trucks will be charged at charging stations with high electrical power (“megawatt charging”). The related art has the disadvantage of lacking or insufficient cooling of the battery, which ultimately means a loss of range because the battery cannot be charged with any energy during the cooling-down phases.

Time is an important factor, in particular for electrically driven trucks, to be able to receive as much energy as possible during prescribed rest periods.

Germany Patent Application No. DE 10 2011 089 293 A1 l describes a battery-charging control method for a vehicle.

Germany Patent Application No. DE 10 2021 206 010 A1 describes a system and method for battery precooling.

It is an object of the present invention to further improve the related art. This object may be solved by certain features of the present invention.

### SUMMARY

The procedure according to an example embodiment of the present invention may have the advantage that the method for the temperature-dependent adjustment of a charging current for a charging process of at least one electrochemical energy store of an electrically driven vehicle comprises the following steps:
setting a maximum charging current value, which represents a maximum permissible charging current depending on a temperature of the electrochemical energy store;
detecting an actual temperature value, which represents at least one instantaneous temperature of the electrochemical energy store;
determining a target charging current value, which represents a permissible charging current for the electrochemical energy store at the instantaneous temperature, depending on the detected actual temperature value using the maximum charging current value;
adjusting the charging current for the charging process of the electrochemical energy store depending on the target charging current value.

Advantageously, interruptions in the charging process can be reduced if the specified temperature limits are not exceeded, in particular if the electrochemical energy store is not cooled or is not cooled sufficiently. This means that as much energy as possible can be stored in electrochemical energy stores, even during a truck driver's short break periods. This is advantageously possible even at high temperatures with a maximum possible charging current, without a shutdown being brought about by a battery management system (BMS) of the electrochemical energy store.

The charging currents go into a kind of “derating” and are reduced accordingly. For the charging process, this means that an electrically driven vehicle, for example an electrically driven truck (HGV), can be charged with a maximum temperature-related charging current and not with a maximum electrical current provided by a charging station, which can reach up to several thousand amperes.

In the method according to an example embodiment of the present invention, the charging current is specified by a temperature profile of the electrochemical energy store that arises in each case and usually lasts at least a few minutes. This advantageously means that there is no pulsed charging in a high frequency range.

Further advantageous embodiments of the present invention are disclosed herein.

Advantageously, according to an example embodiment of the present invention, the target charging current value is determined in such a way that a maximum charging current of a charging current level is achieved depending on the temperature of the electrochemical energy store, without the charging process being interrupted due to thermal heating of the electrochemical energy store.

Thus, with the method according to the present invention, although less energy is supplied in comparison with an electrochemical energy store with a very good cooling system, significantly more energy is supplied in comparison with a priority allocation, which would determine and interrupt the charging process.

An example method for the temperature-dependent adjustment of a charging current for a charging process of an electrochemical energy store of an electrically driven vehicle according to the present invention may further comprise the following steps:
comparing the target charging current value with a specified target charging current threshold;
charging the electrochemical energy store with a first charging current type that represents an alternating current, if the target charging current value falls below the target charging current threshold; or
charging the electrochemical energy store with a second charging current type that represents a direct current, if the target charging current value exceeds the target charging current threshold.

A combination of alternating current and direct current is advantageously possible with a CCS plug. The charging current type is also not limited to direct current or alternating current; it can also advantageously switch from direct current to alternating current, for example if only small currents are permitted.

The maximum charging current value is stored in a temperature-dependent characteristic map and takes into account further values, in particular the state of health (SOH) of the electrochemical energy store, as well as an inertia of a thermal system of the electrochemical energy store.

The temperature-dependent characteristic map advantageously comprises data from electrochemical energy store cells according to a data sheet of the cell manufacturer. The inertia of the thermal system takes into account not only the exceedance of temperature limits but also a safety margin in order to be able to counteract this in good time with smaller charging currents.

The charging current value is stored in a control unit of the electrochemical energy store and/or a control unit of a charging device that can be connected to the electrochemical energy store, and/or the target charging current value is determined by the control unit of the electrochemical energy store and/or the control unit of the charging device.

The charging current for the charging process of the electrochemical energy store is adjusted by the control unit of the electrochemical energy store and/or the control unit of the charging device.

According to an example embodiment of the present invention, a device for operating an electrochemical energy store comprises at least one temperature sensor for detecting a temperature of the electrochemical energy store, and at least one means, in particular an electronic battery management control unit, which are configured to carry out the steps of the method according to the present invention for the temperature-dependent adjustment of a charging current for a charging process of an electrochemical energy store of an electrically driven vehicle.

According to an advantageous example embodiment of the present invention, a computer program is provided, comprising instructions that cause the device to carry out the method steps according to the present invention for operating a battery.

Furthermore, a machine-readable storage medium is provided, on which the computer program is stored.

A method according to an example embodiment of the present invention for the temperature-dependent adjustment of a charging current for a charging process of an electrochemical energy store of an electrically driven vehicle and/or a device for operating an electrochemical energy store is advantageously used in electrochemical energy stores for electric vehicles, electric trucks, fuel cell vehicles, hybrid vehicles, plug-in hybrid vehicles, aircraft, pedelecs and/or e-bikes.

### BRIEF DESCRIPTION OF THE DRAWINGS

Exemplary embodiments of the present invention are illustrated in the figures and explained in more detail in the following description.

FIG. 1 shows a schematic profile of a temperature-dependent charging current, according to an example embodiment of the present invention.

FIG. 2 is a schematic representation of a flow chart of an embodiment of a method according to an example embodiment of the present invention.

### DETAILED DESCRIPTION OF EXAMPLE EMBODIMENTS

In the figures, identical reference signs refer to identical device components.

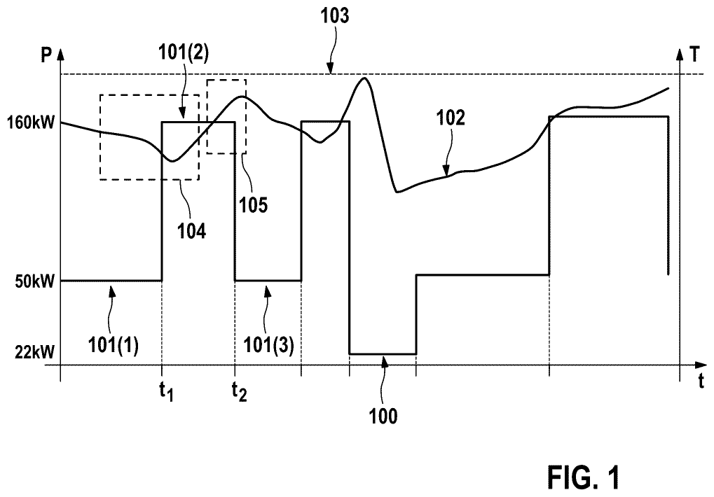

FIG. 1 shows a schematic profile of a temperature-dependent charging current 100.

The duration t of a charging process is shown on the abscissa, a charging power P dependent on the charging current is shown on a first ordinate, and a temperature T of an electrochemical energy store is shown on a second ordinate.

The electrochemical energy store is initially charged at a first charging current level 101(1) with a charging power P of 50 kW. As a result, in an exemplary first period 104, a temperature profile 102 of the electrochemical energy store decreases.

Starting at a time t1, the electrochemical energy store is charged at a second charging current level 101(2) with a charging power P of 160 kW. As a result, in an exemplary second period 105, the temperature profile 102 of the electrochemical energy store increases. Before reaching a maximum temperature 103, which would lead to an interruption of the charging process or a downgrading of a charging priority, the charging current is reduced to a third charging current level 101(3), whereby the charging power P decreases from 160 kW to 50 kW, and the electrochemical energy store cools down as a result.

In the worst case scenario, the charging current switches back and forth between two current strengths, but the charging process does not switch between the charging and non-charging states, which advantageously means that charging can take place continuously.

The charging current therefore always remains below a specified temperature limit and advantageously stores a maximum amount of energy in the electrochemical energy store. Although this does not cause the electrochemical energy store to cool down, which would allow even higher charging currents, charging continues.

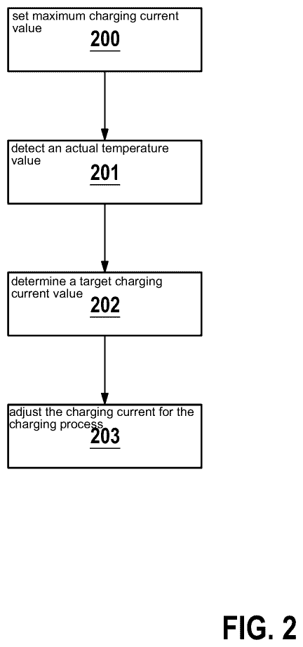

FIG. 2 is a schematic representation of a flow chart of an embodiment of a method according to the present invention.

In a first step 200, a maximum charging current value is set, which represents a maximum permissible charging current depending on a temperature T of the electrochemical energy store.

In step 201, an actual temperature value is detected, which represents at least one instantaneous temperature T of the electrochemical energy store.

In step 202, a target charging current value is determined, which represents a permissible charging current for the electrochemical energy store at the instantaneous temperature T, depending on the detected actual temperature value using the maximum charging current value.

In step 203, the charging current for the charging process of the electrochemical energy store is adjusted depending on the target charging current value.

What is claimed is:

1. A method for a temperature-dependent adjustment of a charging current for a charging process of at least one electrochemical energy store of an electrically driven vehicle, comprising the following steps:
setting a maximum charging current value, which represents a maximum permissible charging current depending on a temperature of the electrochemical energy store;
detecting an actual temperature value, which represents at least one instantaneous temperature of the electrochemical energy store;
determining a target charging current value, which represents a permissible charging current for the electrochemical energy store at the instantaneous temperature, depending on the detected actual temperature value using the maximum charging current value; and
adjusting the charging current for the charging process of the electrochemical energy store depending on the target charging current value.

2. The method according to claim 1, wherein the target charging current value is determined in such a way that a maximum charging current of a charging current level is achieved depending on the temperature of the electrochemical energy store, without the charging process being interrupted due to thermal heating of the electrochemical energy store.

3. The method according to claim 1, further comprising the following steps:
comparing the target charging current value with a specified target charging current threshold;
charging the electrochemical energy store with a first charging current type that represents an alternating current, when the target charging current value falls below the target charging current threshold, and charging the electrochemical energy store with a second charging current type that represents a direct current, when the target charging current value exceeds the target charging current threshold.

4. The method according to claim 1, wherein the maximum charging current value is stored in a temperature-dependent characteristic map and takes into account further values, including a state of health (SOH) of the electrochemical energy store, and an inertia of a thermal system of the electrochemical energy store.

5. The method according to claim 1, wherein: (i) the charging current value is stored in a control unit of the electrochemical energy store and/or a control unit of a charging device that can be connected to the electrochemical energy store, and/or (ii) the target charging current value is determined by the control unit of the electrochemical energy store and/or the control unit of the charging device.

6. The method according to claim 1, wherein the charging current for the charging process of the electrochemical energy store is adjusted by the control unit of the electrochemical energy store and/or the control unit of the charging device.

7. A device for operating an electrochemical energy store, comprising:
at least one temperature sensor configured to detect a temperature of the electrochemical energy store; and
an electronic battery management control unit configured for q temperature-dependent adjustment of a charging current for a charging process of an electrochemical energy store of an electrically driven vehicle, the control unit configured to:
set a maximum charging current value, which represents a maximum permissible charging current depending on a temperature of the electrochemical energy store;
detect an actual temperature value, which represents at least one instantaneous temperature of the electrochemical energy store;
determine a target charging current value, which represents a permissible charging current for the electrochemical energy store at the instantaneous temperature, depending on the detected actual temperature value using the maximum charging current value; and
adjust the charging current for the charging process of the electrochemical energy store depending on the target charging current value.

8. A non-transitory machine-readable storage medium on which is stored a computer program for a temperature-dependent adjustment of a charging current for a charging process of at least one electrochemical energy store of an electrically driven vehicle, the computer program, when executed by a processor, causing the processor to perform the following steps:
setting a maximum charging current value, which represents a maximum permissible charging current depending on a temperature of the electrochemical energy store;
detecting an actual temperature value, which represents at least one instantaneous temperature of the electrochemical energy store;
determining a target charging current value, which represents a permissible charging current for the electrochemical energy store at the instantaneous temperature, depending on the detected actual temperature value using the maximum charging current value; and
adjusting the charging current for the charging process of the electrochemical energy store depending on the target charging current value.

9. The method according to claim 1, wherein the electrically driven vehicle is: an electric truck, and/or a fuel cell vehicle, and/or a hybrid vehicle, and/or a plug-in hybrid vehicle, and/or an aircraft, and/or a pedeles, and/or an e-bike.
